(19) United States
(12) Patent Application Publication
(10) Pub. No.: US 2025/0164079 A1
(43) Pub. Date: May 22, 2025

(54) METHOD FOR CONTROLLING A MONITORING UNIT FOR THE RESIDUAL SUPPLY TIME FOR THE GAS PRESENT IN A PRESSURIZED CONTAINER AND VALVE CONFIGURED SO AS TO CARRY OUT THE METHOD

(71) Applicant: CAVAGNA GROUP S.P.A., Calcinato (IT)

(72) Inventors: Matteo Compagnoni, Sulzano (IT); Giancarlo Nicolini, Villanuova (IT); Paolo Ragnoli, Poncarale (IT)

(73) Assignee: CAVAGNA GROUP S.P.A., Calcinato, OT (IT)

(21) Appl. No.: 18/838,544

(22) PCT Filed: Feb. 17, 2023
(86) PCT No.: PCT/IB2023/051456

§ 371 Date: Aug. 14, 2024

(30) Foreign Application Priority Data
Feb. 17, 2022 (IT) 102022000002933

(51) Int. Cl. F17C 13/02; F17C 13/04

(52) U.S. Cl. CPC F17C 13/025; F17C 13/026; F17C 13/028; F17C 13/04; F17C 2201/032; F17C 2205/0165; F17C 2205/0308; F17C 2205/0329; F17C 2205/0394; F17C 2205/057; F17C 2221/011; F17C 2223/0123; F17C 2250/032; F17C 2250/036; F17C 2250/0426; F17C 2250/0434; F17C 2250/0439; F17C 2250/0473; F17C 2250/0478; F17C 2250/072; F17C 2270/025

(57) ABSTRACT

A method for controlling a monitoring unit for the residual supply time for the gas present in a pressurized container includes associating with a plurality of angular positions respective residual time values in accordance with a selected flow; measuring the angular position of the control element by means of a magnetic tunnel effect angle sensor. A residual time value is determined in accordance with the selected flow corresponding to the angular position of the rotary control element; measuring an intensity of the magnetic field by means of the magnetic tunnel effect angle sensor TMR. A limit intensity value is defined for the magnetic field. A display device displays the residual time value in accordance with the selected flow only if the intensity of the magnetic field measured is less than the limit value.

The present invention relates to a method for controlling a monitoring unit for the residual supply time for the gas present in a bottle or other pressurized container. The supply is carried out through a valve group of the type comprising a shutoff device which is capable of intercepting an outlet opening of the valve group in order to prevent the flow of gas being discharged, and a rotary control element which is configured to move the shutoff device from a closed position to an open position. The invention also relates to a valve group comprising a control unit which is configured to carry out the above-mentioned method.

More generally, the present invention is used, though not exclusively, in the technical sector of technical and medical gas storage within suitable pressurized containers.

These containers are widely used as containers for high-pressure gas, such as, for example, oxygen, air, industrial gases or gases for medical and domestic use, and provide for the presence of suitable valves which are intended for supplying the gas and where applicable regulating the pressure thereof.

In some technical fields, such as, for example, the medical field, it is desirable to provide the valve with an information system which is capable of providing the user with a series of data and information items relating to the operating conditions of the gas present in the container in addition to the pressure value supplied by a conventional pressure gauge.

To this end, there are known solutions in which the valves are provided with electronic devices such as pressure sensors for reading the pressure in the bottle, heat sensors for measuring the temperature of the system—the use of logic units capable of processing these data making it possible to predict the end of use in accordance with current consumption—alarm systems connected with combinations of data evaluated as being at risk.

In some technical fields, the need to be able to have a precise and reliable indication of the residual supply time of the gas present inside a container is particularly perceived. Consider, for example, the medical field, in which it is necessary to reliably know for how much time a bottle will still be able to supply oxygen to a patient in order to be able to programme the replacement thereof or in any case the interventions required at the end of the supply thereof. This necessity may further be perceived in all the technical fields in which it is necessary to know for how much time a bottle will be able to supply the gas contained therein.

Examples of valves provided with systems capable of supplying an indication of the residual supply time are described in EP3754245, U.S. Pat. Nos. 9,273,799, 9,816,642, EP3405716 or EP3097342.

In these known solutions, the residual capacity of the bottle is calculated by means of an estimate based either on the position of the wheel or on the pressure conditions inside the bottle.

However, it is desirable to improve the reliability and the precision in estimating the residual capacity of the bottle under the different operating conditions.

Therefore, the problem addressed by the present invention is to provide a method for controlling a monitoring unit for the residual supply time of the gas present in a pressurized container through a valve group which is functionally configured to at least partially overcome one or more of the disadvantages set out with reference to the cited prior art.

This problem is solved and one or more of these objects are at least partially achieved by the invention by a method for controlling a monitoring unit for the residual supply time for the gas present in a pressurized container through a valve group which:
a. associates with a plurality of angular positions respective residual time values in accordance with a selected flow;
b. measures the angular position of the control element by means of a magnetic tunnel effect angle sensor TMR;
c. determines a residual time value in accordance with the selected flow corresponding to the angular position of the rotary control element;
d. measures an intensity of the magnetic field by means of the magnetic tunnel effect angle sensor TMR;
e. defines a limit intensity value (z) for the magnetic field;
displaying on the display device the residual time value in accordance with the selected flow only if the intensity of the magnetic field measured is less than the limit value.

It will be appreciated that, by using a magnetic tunnel effect angle sensor TMR, it is possible to recognize the presence of a magnetic field without requiring the presence of additional instruments, with a solution which is economical and which does not require additional energy consumption for the implementation thereof.

In this manner, the same selection used for the instruments which is provided for monitoring the supply conditions can also be used to verify the actual operation thereof.

Preferably, the method provides for measuring a pressure value of the gas inside the pressurized container so as to be able to use this value if the presence of a magnetic field is detected.

In some embodiments, there is provision for displaying the pressure value if the intensity of the magnetic field measured is greater than the limit value.

The method may further preferably provide for:
a. calculating a residual time value in accordance with the pressure (TRDP) of the pressure value (P);
b. comparing the residual time value in accordance with the selected flow (TRV) and the residual time value in accordance with the pressure (TRDP);
c. if the intensity of the magnetic field measured is less than the limit value (z), displaying on the display device (103) the residual time value in accordance with the selected flow (TRV) or the residual time value in accordance with the pressure (TRDP) in accordance with one or more operating parameters of the valve group (100) and/or the pressurized container (B).

In other words, on the basis of this aspect, the method uses a more developed monitoring algorithm if a magnetic field is not detected, making the measurement of the parameters necessary for carrying out this algorithm less precise and/or reliable.

Preferably, the above-mentioned operating parameters comprise one or more from: time passed from an initial time of the passage of the gas flow, pressure measured inside the container, temperature of the gas, volume of the container, angular position of the rotary control element.

In some embodiments, the method provides for calculating a difference between the residual time value in accordance with the selected flow and the residual time value in accordance with the pressure.

Therefore, it is possible to display the residual time value in accordance with the selected flow before a predetermined time period, independently of the one or more operating parameters of the valve group and/or the pressurized container, preferably without carrying out the calculation of the difference between the residual time value in accordance with the selected flow and the residual time value in accordance with the pressure.

This allows a modification of the methods with which the residual time for the gas is calculated in accordance with specific operating conditions and particularly in accordance with two different methods for calculating the residual time.

At the initial supply times, it may then be preferable to display directly the residual time value in accordance with the selected flow, thereby limiting the requirements for a calculation in these steps, and allowing an immediate value which is sufficiently precise to be provided.

Conversely, the calculation of the difference between the residual time value in accordance with the selected flow and the residual time value in accordance with the pressure is preferably carried out after a predetermined time period has passed from an initial time of the passage of the gas flow.

According to yet another aspect, the residual time value in accordance with the selected flow is displayed if the difference between the residual time value in accordance with the selected flow and the residual time value in accordance with the pressure is less than a first threshold. In this manner, use is made of the residual time value in accordance with the selected flow if it is verified that the two values provide coherent results and, therefore, between the two the one which is less subjected to oscillations is favoured.

In some embodiments, the residual time value in accordance with the pressure is displayed if a predetermined time period has passed and the difference between the residual time value in accordance with the selected flow and the residual time value in accordance with the pressure is greater than the first threshold. Under these different conditions, therefore, it is preferable to display the residual time value in accordance with the pressure because the other value might not be significant.

According to another aspect, the invention also relates to a valve group for pressurized containers comprising a main structure and a rotary control element which is rotatably connected to the main structure and which is configured so as to allow a flow of gas through the valve group in accordance with an angular position thereof about a main rotation axis.

The valve group includes a measuring device which comprises a main structure, a rotary control element which is rotatably connected to the main structure and which is configured so as to allow a flow of gas through the valve group in accordance with an angular position thereof.

The valve group further comprises a measuring device which includes an angular position sensor and a movable member, the angular position sensor being configured to measure the angular position of the movable member about an auxiliary rotation axis.

The valve group further comprises a control unit which is configured so as to carry out the method of the present invention and the preferred features thereof, such as, for example, the ones set out above.

In some embodiments, the valve group further comprises a movement conversion mechanism which is configured so as to convert the movement of the rotary control element about the main axis into a corresponding rotational movement of the movable member about the auxiliary axis. The auxiliary axis is different from the main rotation axis.

Preferably, the auxiliary rotation axis is parallel with and offset with respect to the main rotation axis.

It will be appreciated that, in addition to the above-mentioned advantages, as a result of the possibility of precisely measuring the position of the control element during the supply, it is possible to instruct the logic unit to supply during the first times of use coherent hypotheses for duration based on a calculation routine.

The use of a mechanism which is capable of converting the rotation of the control element into the rotation about a different axis further advantageously allows movement of the sensor portion outside the control element, contributing to the construction simplicity of the valve group. At the same time, the rotational movement which is transmitted allows a solution which takes up little space to be obtained.

Preferably, the angular position sensor is a magnetic tunnel effect angle sensor TMR.

According to some aspects of the invention, the angular position sensor defines a measurement axis Y′ which is aligned with the auxiliary rotation axis.

On the basis of this aspect, therefore, the sensor can be aligned with the magnet which is present in the movable member.

This feature contributes to minimizing the energy consumption of the sensor, advantageously allowing a long duration of the batteries which are necessary for the operation thereof.

Using a TMR type sensor is further particularly advantageous for the measurement precision and the reduced levels of consumption.

In some embodiments, the movement conversion mechanism comprises a first toothed portion which is fixedly joined in terms of rotation to the control element and a second toothed portion which is fixedly joined in terms of rotation to the movable member and which meshes with the first toothed portion.

Preferably, the first toothed portion is constructed in the region of a collar which is formed in the control element.

As a result of these aspects, it is possible to construct a particularly simple and reliable mechanism which has small dimensions.

It will be appreciated that the preferred features of one aspect of the invention may also be applied to the other aspects of the invention. Furthermore, preferred features of the invention will be more generally defined by the dependent claims.

The features and advantages of the invention will be better appreciated from the detailed description of a number of embodiments thereof which are illustrated by way of non-limiting example with reference to the appended drawings, in which:

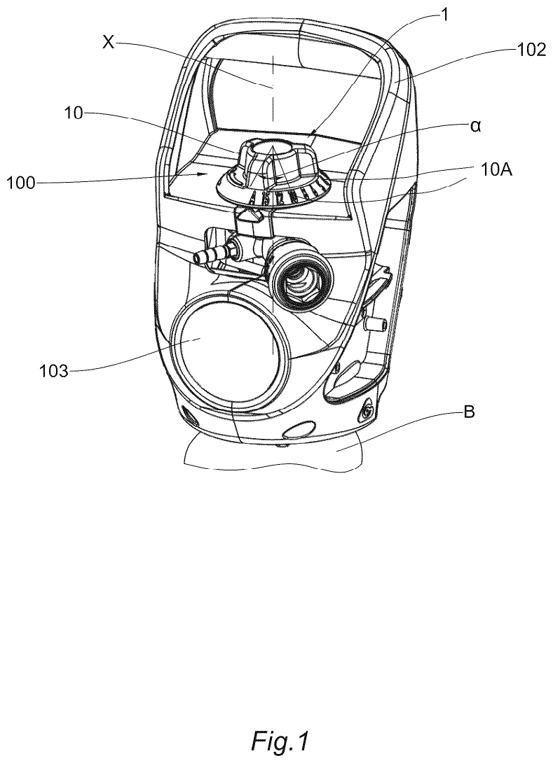

FIG. 1 is a perspective view of a valve group according to the present invention during use in a pressurized container;

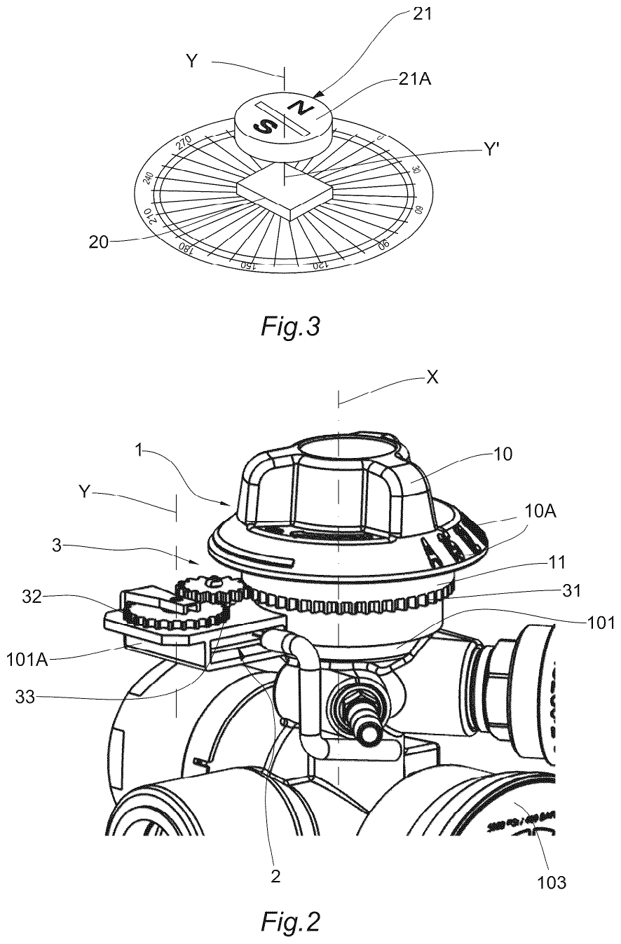

FIG. 2 is a perspective view of a valve group according to the present invention;

FIG. 3 is a perspective view of a valve group according to an alternative embodiment of the present invention;

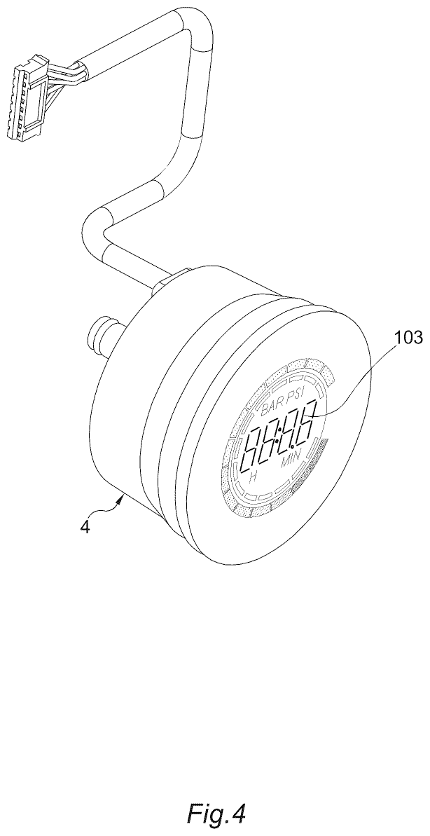

FIG. 4 is a perspective view of a control unit and a relevant display device of the valve group according to the present invention; and

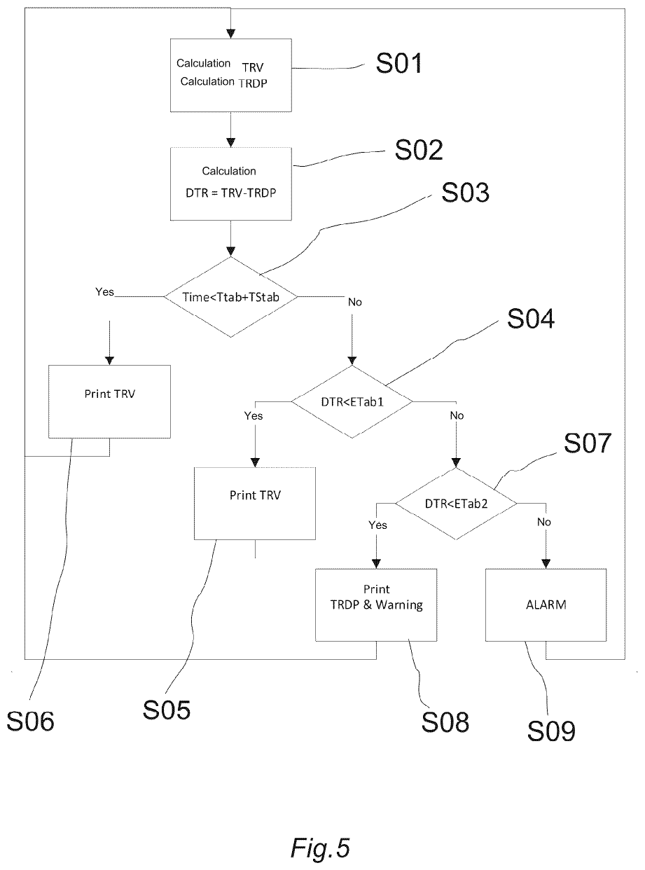

FIG. 5 is a block diagram which illustrates a possible embodiment of the method according to the present invention.

Initially with reference to FIG. 1, a valve group according to the present invention is generally designated 100.

The valve group 100 is of the type intended for use in a pressurized container, for example, a bottle B, in order to control the discharge, and where applicable the intake in the refilling step, of the pressurized gas present inside the container.

The valve group 100 can advantageously be combined with a protection shell 102, which is provided with a handle, where applicable, and a display, or other display device 103, which is capable of indicating parameters or conditions which are characteristic of the gas present inside the container, as will be set out in greater detail below.

Now also with reference to FIG. 2, the valve group 100 preferably comprises a control element 1 which can be partially projecting from the protection shell 102 in order to allow the manual actuation thereof by acting on a suitable gripping portion 10.

On the basis of an aspect of the invention, when the control element 1 is rotated in one direction, there is released a passage of gas being discharged from the valve group 100, supplying the gas present inside the pressurized container. A rotation in the opposite direction then brings about the closure thereof again. To this end, the valve group 100 may comprise a shutoff device which is not illustrated in the Figures and which is capable of intercepting a gas outlet opening.

In other words, when the shutoff device is closed, the gas is prevented from being discharged, by the control element 1 being rotated the shutoff device is opened and the gas can be supplied.

The rotation of the control element 1 is preferably carried out about a main rotation axis X.

Under normal supply conditions, for example, in the absence of obstructions or with a sufficiently full bottle, the angular position α of the control element about the rotation axis X determines the flow rate of gas which is supplied through the valve group 100. This may, for example, be brought about by throttling the opening of the shutoff device.

In order to allow the user to evaluate the position of the control element, and therefore the opening level of the valve group, the control element 1 may comprise a plurality of reference elements 10A which are positioned along a peripheral portion thereof and which correspond to various angular positions of the control element. These reference elements can, for example, be formed by reference numerals which indicate the flow rate of gas being supplied or a percentage with respect to the maximum opening of the valve group 100.

Still with reference to FIG. 2, the valve group of the present invention further comprises a measuring device 2, by means of which the angular position α of the control element 1 can be determined indirectly. In this manner, the measuring device 2 will be able to measure any rotations of the control element 1 and the consequent opening of the shutoff device and therefore generally the valve group 100.

In preferred embodiments, the measuring device 2 includes an angular position sensor 20 and a movable member 21, which preferably comprises a magnet 21A, as better illustrated in the example of FIG. 2 and in FIG. 3.

The movable member 21 is advantageously rotatably supported on the main structure about an auxiliary rotation axis Y.

As will be better appreciated below, the auxiliary rotation axis Y is different from the main rotation axis X of the control element. In other words, the two axes are not mutually aligned. In some embodiments, the rotation axis Y can be parallel with and not aligned with the axis X.

As may be observed in FIG. 2, the measuring device is preferably arranged laterally relative to the control element 1, i.e. arranged at the side thereof in a radial direction with respect to the axis X.

In preferred embodiments, the angular position sensor 20 is a magnetic tunnel effect angle sensor TMR. The angular position sensor 20 is therefore preferably configured to measure the angular position of the movable member 21 about the auxiliary rotation axis Y.

To this end, the movable member 21 is advantageously supported rotatably on the main structure 101 and the angular position sensor 20 is fixed to the main structure 101.

As may be observed from the example of FIG. 3, the angular position sensor 20 preferably defines a measurement axis Y′, where applicable formed by the geometric centre of the sensor 20, which can advantageously be aligned with the auxiliary axis Y.

In other words, the magnet 21A and the sensor are coaxial so as to optimize the operation of the device.

It will be appreciated that, in some embodiments, the magnet 21A is substantially discoid in form and, indeed, is coaxial with the auxiliary rotation axis Y.

Now going into detail with regard to the kinematic characteristics of the valve group, as may be observed in FIG. 2, the valve group 100 may comprise a movement conversion mechanism 3 in order to transmit the movement from the control element 1 to the movable member 21.

The movement conversion mechanism 3 is advantageously configured so as to convert the movement of the rotary control element 1 about the main axis X into a corresponding rotational movement of the movable member 21 about the auxiliary axis Y.

The movement may advantageously be brought about with a multiplication transmission ratio in order to increase the sensitivity of the sensor. In some embodiments, the movement conversion mechanism 3 comprises a first toothed portion 31 which is fixedly joined in terms of rotation to the control element 1 and a second toothed portion 32 which is fixedly joined in terms of rotation to the movable member 20 and which meshes with the first toothed portion 31. In other words, the transmission of the movement can be carried out by means of a gearing system.

Preferably, the first toothed portion 31 is constructed in the region of a collar 11 which is formed in the control element 1, as can better be seen in FIG. 2.

In some embodiments, there may further be provided a step-down mechanism 33 which is, for example, formed by a pair of gears which are coaxial and which engage with the first toothed portion 31 and the second toothed portion 32, respectively.

The valve group 100 further comprises a control unit which receives the angular position α which is acquired by means of the angular position sensor 20.

This data item may advantageously be used to determine a residual time value in accordance with the selected flow TRV corresponding to the angular position α of the rotary control element 1. It will be appreciated that, in the context of the present invention, the term “residual time value in accordance with the selected flow TRV” will indicate a residual time value for supplying the gas contained inside the bottle, i.e. a residual capacity, which is calculated on the basis of the gas flow selected by means of the rotary control element 1. In this case, the actual physical characteristics for supplying the gas are not taken into consideration in order to calculate this value.

In order to associate a corresponding residual time value TRV with the different angular positions x, there may be provision for creating a data table, which is preferably stored in a storage unit of the control unit 4 and in which a residual supply time is associated with each angular position α of the rotary control element 1. In fact, under normal operating conditions, the gas flow supplied from the valve group is kept constant over time and this allows the residual supply time to be determined by means of experimental tests, where applicable in accordance with the type of bottle B used.

In fact, it will be possible to define tables for each type of bottle for which the valve group may be intended and to provide, during the installation step, or during a set-up step, the possibility of using the correct type of bottle.

However, the Applicant has observed that this residual time value TRV is not always completely representative of the actual gas flow. In fact, there may be found to be situations in which the flow is obstructed, for example, by obstructions of the tube, or situations in which the behaviour of the valve group is different from the operating situations, such as, for example, at the initial supply times or when the bottle is in the depleted phase.

To this end, the valve group also provides for the possibility of calculating a residual time value in accordance with the pressure TRDP on the basis of a pressure value P of the gas which is present inside the bottle B. To this end, the valve group 100 may comprise a pressure sensor which is not illustrated in the Figures and which is capable of measuring this pressure value P.

Preferably, the residual time value in accordance with the pressure TRDP is calculated according to the formula:

$$TRDP = \frac{( P ( {T}_{2} ) * {V}_{b} )}{{Q}_{m}} + {T}_{2}$$

where T2 is the time which has passed from the start of the supply; P(T2) is the pressure inside the container at the time T2; Vb is the volume of the bottle; Qm is a gas flow value associated with the angular position of the control element.

The Applicant has confirmed that, under normal gas supply conditions, the residual time value in accordance with the selected flow TRV and the residual time value in accordance with the pressure TRDP have similar values. By comparing the two values, therefore, it is possible to understand whether the gas supply is being carried out under normal conditions and therefore it is possible to use the residual time value in accordance with the selected flow TRV as an indication of the residual capacity of the bottle, or not.

It will be appreciated that, in the context of the present invention, the term “normal conditions” is preferably intended to be understood to mean conditions in which there occurs one or more of the following conditions: the flow is not obstructed, for example, as a result of obstructions in the structure of the valve group or in the supply tube, the transient supply start step has been depleted, the pressurized container is not near depletion.

In preferred embodiments, the comparison between the residual time value in accordance with the selected flow TRV and the residual time value in accordance with the pressure TRDP provides for calculating the difference DTR between these values, as illustrated in the step S02 of the block diagram of FIG. 5.

This difference is therefore compared with a first predefined threshold ETab1 in the step S04.

If the difference DTR between the residual time value in accordance with the selected flow TRV and the residual time value in accordance with the pressure TRDP is less than this first threshold ETab1, then the residual time value TRV is displayed, as described in FIG. 5 in the step S05. In fact, this condition confirms that the two values are sufficiently comparable and the residual time value TRV can advantageously be used. The first threshold ETab1 can be determined on the basis of experimental tests, observing what is the variation between the two values if the operating conditions deviate from the normal ones.

If the difference exceeds this threshold, the difference is preferably compared with a second threshold ETab2, which is greater than the first threshold, as described in the step S07.

If the difference DTR between the residual time value in accordance with the selected flow TRV and the residual time value in accordance with the pressure TRDP is greater than the first threshold ETab1, but less than the second threshold ETab2, then the residual time value in accordance with the pressure TRDP is displayed, preferably together with a warning signal, because this deviation could indicate the occurrence of a number of problems (step S08).

If, instead, the second threshold ETab2 is also exceeded, there may be provision for the system to supply an alarm signal because this deviation between the two residual time values could indicate that the supply is not being carried out correctly (step S09).

In addition, there may be provision, before a predetermined time period has passed from an initial time of the passage of the gas flow, for the residual time value in accordance with the selected flow TRV to be in any case displayed regardless of the other parameters, as illustrated in the step S06 in the diagram of FIG. 5.

In this case, it is not necessary to carry out the calculation of the difference DTR between the residual time value in accordance with the selected flow TRV and the residual time value in accordance with the pressure TRDP which may therefore start to be carried out after the predetermined time period mentioned above has passed. In this manner, account can be taken of the fact that during the transient supply start steps the measurement of the residual time by means of pressure readings could be insufficiently reliable.

The method set out above may therefore be advantageously carried out by the control unit 4 of the valve group 100 which in turn transmits one value or the other or the potential alarm signal to the display 103.

The control unit 4 further allows the valve group to be provided with additional functionalities. As mentioned above, the normal supply of the gas can be monitored by considering operating parameters of the valve group or the pressurized container which include one or more from: time passed from an initial time of the passage of the gas flow, pressure P measured inside the container, temperature T of the gas, volume Vb of the container, angular position α of the rotary control element 1.

According to another aspect of the invention, the valve group may also be configured to measure an obstructed tube condition by considering a number of the above-mentioned parameters.

In fact, the Applicant has observed that, by monitoring the pressure and temperature, there can be identified situations in which the supply tube of the gas can be at least partially obstructed.

In preferred embodiments, this is carried out by considering the pressure increase which occurs at two different gas supply times and a temperature variation between the same times.

To this end, the control unit 4 can therefore be interfaced with the pressure sensor so as to measure the pressure P of the gas inside the pressurized container B at two different times. In particular, there may be defined a first time T0 and a second time Tf, after the first time T0, which define a predetermined time period.

The control unit 4 is further interfaced with a temperature sensor, which is preferably arranged on a supply pipe of the valve group so as to also measure the temperature of the gas at these times T0, Tf.

On the basis of these values, there is then calculated a pressure difference DP between the pressure measured at the first time and the pressure measured at the second time Tf and a temperature difference DTemp between the temperature measured at the first time T0 and the temperature measured at the second time Tf.

These values can advantageously be used in order to monitor the correct flow of gas through the supply tube. In fact, if the conditions for which the pressure difference DP is less than a predetermined value and the temperature difference DTemp is greater than or equal to zero occur simultaneously, it may be hypothesized that there is an obstruction in the supply tube.

This predetermined pressure value can be determined by means of experimental tests, for example, by simulating an obstruction of the tube and monitoring the progression of the pressure under such conditions.

Furthermore, the predetermined pressure value may be a function of the angular position α of the control element 1, i.e. it may be variable in accordance with the gas flow imposed by the user.

Preferably, the pressure and temperature measurement can also be associated with the angular position α of the control element 1 in order to prevent the monitoring of the tube from taking place when the valve group 100 is closed. In other words, the pressure of the gas and the temperature of the gas can be measured only when the control element 1 is rotated into an open position of the valve group 100.

The time period defined by the difference between the first time T0 and the second time Tf can also be variable in accordance with the angular position α of the control element 1.

Preferably, this time period decreases with an increase in the flow rate of gas imposed on the basis of the angular position α of the control element 1.

In this manner, the measurement frequency increases with an increase of the flow rate of the gas, allowing a reduction in the calculation operations carried out at the low flow rates, thereby optimizing the energy consumption of the control unit 4.

In one preferred embodiment, the time period may, for example, take up two different values. The passage between the two values can be carried out when the control element 1 exceeds a limit position αlim. In this manner, when the control element 1 is in a position between a closed position and the limit position αlim, the time period takes up the first value and, when it exceeds the limit position αlim, the time period takes up the second value.

In some embodiments, this limit position αlim corresponds to a value between ⅕ and 1/10 of the maximum flow rate of gas which can be supplied through the valve group 100 and, preferably, it corresponds to a flow rate of 2 l/min.

On the basis of yet another aspect, the valve group may also be configured to take into account the possible presence of a magnetic field which could compromise one or more functionalities of the system.

This function is preferably performed by means of the magnetic tunnel sensor which is used in the valve group 100. The magnetic tunnel sensor can in fact also advantageously be used to measure an intensity of the magnetic field.

Therefore, a limit value for the intensity of the magnetic field z can be defined, within which limit value the sensor operates correctly.

Consequently, the control unit 4 can be configured so as to display on the display device 103 the residual time value in accordance with the selected flow TRV and where applicable the residual time value in accordance with the pressure TRDP only if the intensity of the magnetic field measured is less than the limit value z.

Vice versa, if the intensity of the magnetic field measured is greater than the limit value z, the control unit 4 can display the pressure value P and, where applicable, generate an alarm signal.

The invention thereby solves the problem proposed, at the same time achieving a plurality of including advantages, the possibility of efficiently informing the user with regard to the duration of possible gas supply from the bottle, limiting the risks of the gas becoming depleted. Furthermore, the valve group of the present invention allows the device to be readily provided with a number of functionalities with a simple and actual solution.

1. A method for controlling a monitoring unit for the residual supply time (TR) for the gas present in a pressurized container through a valve group, the monitoring unit being included in the valve group, the valve group comprising a main structure, a rotary control element which is rotatably connected to the main structure and which is configured so as to allow a passage of a variable flow of gas through the valve group in accordance with an angular position (α) thereof about a main rotation axis (X), wherein the monitoring unit includes a control unit and a display device, the method comprising:
a. associating with a plurality of angular positions (α1 . . . αn) respective residual time values in accordance with a selected flow (TRV);
b. measuring the angular position (α) of the control element by means of a magnetic tunnel effect angle sensor TMR;
c. determining a residual time value in accordance with the selected flow (TRV) corresponding to the angular position (α) of the rotary control element;
d. measuring an intensity of the magnetic field by means of the magnetic tunnel effect angle sensor TMR;
e. defining a limit intensity value (z) for the magnetic field; and
f. displaying on the display device the residual time value in accordance with the selected flow (TRV) only if the intensity of the magnetic field measured is less than the limit value (z).

2. The method according to claim 1, comprising measuring a pressure value (P) of the gas inside the pressurized container.

3. The method according to claim 2, comprising displaying the pressure value (P) if the intensity of the magnetic field measured is greater than the limit value (z).

4. The method according to claim 2, comprising:
a. calculating a residual time value in accordance with the pressure (TRDP) of the pressure value (P);
b. comparing the residual time value in accordance with the selected flow (TRV) with the residual time value in accordance with the pressure (TRDP);
c. selecting a value from the residual time value in accordance with the selected flow (TRV) and the residual time value in accordance with the pressure (TRDP) in accordance with one or more operating parameters of the valve group (100) and/or the pressurized container; and
d. if the intensity of the magnetic field measured is less than the limit value (z), displaying on the display device the value selected from the residual time value in accordance with the selected flow (TRV) or the residual time value in accordance with the pressure (TRDP).

5. The method according to claim 4, wherein the operating parameters comprise one or more from: time passed from an initial time of the passage of the gas flow, pressure (P) measured inside the container, temperature (T) of the gas, volume (Vb) of the container, angular position (a) of the rotary control element.

6. The method according to claim 4, further comprising calculating a difference (DTR) between the residual time value in accordance with the selected flow (TRV) and the residual time value in accordance with the pressure (TRDP).

7. The method according to claim 4, comprising displaying the residual time value in accordance with the selected flow (TRV) before a predetermined time period, independently of the one or more operating parameters of the valve group and/or the pressurized container, preferably without carrying out the calculation of the difference between the residual time value in accordance with the selected flow (TRV) and the residual time value in accordance with the pressure (TRDP).

8. The method according to claim 7, wherein the calculation of the difference (DTR) between the residual time value in accordance with the selected flow (TRV) and the residual time value in accordance with the pressure (TRDP) is carried out after a predetermined time period has passed from an initial time of the passage of the gas flow.

9. The method according to claim 4, wherein the residual time value in accordance with the selected flow (TRV) is displayed if the difference (DTR) between the residual time value in accordance with the selected flow (TRV) and the residual time value in accordance with the pressure (TRDP) is less than a first threshold (ETab1).

10. The method according to claim 9, wherein the residual time value in accordance with the pressure (TRDP) is displayed if a predetermined time period has passed and the difference (DTR) between the residual time value in accordance with the selected flow (TRV) and the residual time value in accordance with the pressure (TRDP) is greater than the first threshold (ETab1).

11. A valve group for pressurized containers comprising a main structure, a rotary control element which is rotatably connected to the main structure and which is configured so as to allow a flow of gas through the valve group in accordance with an angular position (α) thereof about a main rotation axis (X), a measuring device which includes an angular position sensor and a movable member, the angular position sensor being a magnetic tunnel effect angle sensor TMR and being configured to measure the angular position of the movable member about an auxiliary rotation axis (Y), the valve group further comprises a control unit which is configured so as to carry out the method according to claim 1.
